(19) United States
(12) Patent Application Publication
(10) Pub. No.: US 2017/0103562 A1
(43) Pub. Date: Apr. 13, 2017

(54) SYSTEMS AND METHODS FOR ARRANGING SCENES OF ANIMATED CONTENT TO STIMULATE THREE-DIMENSIONALITY

(71) Applicant: Disney Enterprises, Inc., Burbank, CA (US)

(72) Inventor: Kenneth Mitchell, Earlston (GB)

(73) Assignee: Disney Enterprises, Inc.

(21) Appl. No.: 14/878,326

(22) Filed: Oct. 8, 2015

(51) Int. Cl. G06T 13/20; G06T 7/00

(52) U.S. Cl. CPC G06T 13/20; G06T 7/004

(57) ABSTRACT

Systems and methods for arranging scenes of animated content are presented herein. Scenes may be arranged to simulate three-dimensionality in the scenes by shifting objects in the scenes relative to each other and/or changing other properties of one or more of the objects. A shift and/or other property change may be based on a position and/or orientation of a display of a computing platform presenting the scenes relative to a user's perspective of the display.

### FIELD OF THE DISCLOSURE

This disclosure relates to arranging scenes of animated content to simulate three-dimensionality in the scenes presented via a two-dimensional display by positionally shifting objects corresponding to different depth layers of the scenes relative to each other, wherein the positional shift is based on a position and/or orientation of the display presenting the scenes relative to a user's view perspective of the display.

### BACKGROUND

Animated content may be presented on two-dimensional displays of computing platforms (e.g., flat-screen displays). Animators may wish to create content in a manner to simulate three dimensional (“3D”) effects. Generating these effects may require substantial processing power and may not be suitable for all viewing situations. For example, mobile computing platforms such as smartphones or tables may not have requisite processing capabilities to facilitate three-dimensionality in presented scenes. As another example, viewing 3D scenes may require users to wear special glasses, which may be cumbersome, inconvenient, and/or otherwise undesirable.

### SUMMARY

One aspect of the disclosure relates to a system for arranging scenes of animated content to simulate three-dimensionality effects using one or more low processing cost techniques. One or more effects may be accomplished by shifting objects corresponding to different depth layers of the scenes relative to each other based on a position and/or orientation of a display of a computing platform presenting the scenes relative a user's perspective of the display.

In some implementations, the system may comprise one or more physical processor configured by machine-readable instructions. The machine-readable instructions may comprise one or more of a layer component, a relative projection component, a shift component, an arranging component, and/or other components.

The layer component may be configured to associate objects in the scenes of the animated content with discrete layers. The layers may correspond to depth positions of the objects within the scenes. In some implementations, individual layers may correspond to different depths of simulated depth-of-field within the scenes. By way of non-limiting example, a first object of a first scene may be associated with a first layer. A second object of the first scene may be associated with a second layer. The first layer may correspond to a first depth of a simulated depth-of-field of the first scene. The second layer may correspond to a second depth of the simulated depth-of-field of the first scene.

The relative projection component may be configured to determine relative projection information for individual ones of the scenes. The relative projection information may convey one or both of position and/or orientation of a display of a computing platform presenting the scenes relative to a user's perspective of the display. By way of non-limiting example, relative projection information may include first relative projection information associated with a first scene. The first relative projection information may convey one or more changes in the user's perspective of the display while viewing the first scene.

The shift component may be configured to determine relative positions of the objects in layers of the scenes based on the relative projection information. The shift component may be configured to determine other property changes to the objects in the scenes based on the relative projection information. By way of non-limiting example, the shift component may be configured to determine that the first object may positionally shift in relation to the second object responsive to a change in the user's perspective of the display while viewing the first scene. By way of non-limiting example, the positional shift and/or other property changes may facilitate simulating three-dimensionality of the first scene.

The arranging component may be configured to arrange the scenes based on the determined relative positions. By way of non-limiting example, the first scene may be arranged based on the determined positional shift of the first object relative the second object. In some implementations, views of the arranged scenes may be accessible by user via computing platforms associated with the users.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise.

### BRIEF DESCRIPTION OF THE DRAWINGS

FIG. 1 illustrates a system for arranging scenes of animated content to simulate three-dimensionality in the scenes, in accordance with one or more implementations.

FIG. 2 illustrates an exemplary implementation of a server employed in the system of FIG. 1.

FIG. 3 illustrates a representation of an individual frame of a scene of animated content depicting different layers that correspond with different depths of simulated depth-of-field within the scene, in accordance with one or more implementations.

FIG. 4 illustrates an exemplary implementation of a frame of a scene of the animated content based on relative projection information conveying a user's relative perspective of a display of a computing platform presenting the scene.

FIG. 5 illustrates an exemplary implementation of a frame of a scene of the animated content based on relative projection information conveying a user's relative perspective of a display of a computing platform presenting the scene that is different than the user's relative perspective associated with the arrangement depicted in FIG. 4.

FIG. 6 illustrates an exemplary implementation of a rendered frame of a scene of the animated content based on relative projection information conveying a user's relative perspective of a display of a computing platform presenting the scene that is different than the user's relative perspectives associated with the arrangements depicted in FIG. 4 and FIG. 5.

FIG. 7 illustrates different user perspectives of a display of a computing platform based different orientations of the user relative the display, in accordance with one or more implementations.

FIG. 8 illustrates different user perspectives of a display based different orientations of the display relative the user, in accordance with one or more implementations.

FIG. 9 illustrates an implementation of user perspective being represented at least in part by a point within a coordinate system, in accordance with one or more implementations.

FIG. 10 illustrates a method of arranging scenes of animated content to simulate three-dimensionality in the scenes, in accordance with one or more implementations.

### DETAILED DESCRIPTION

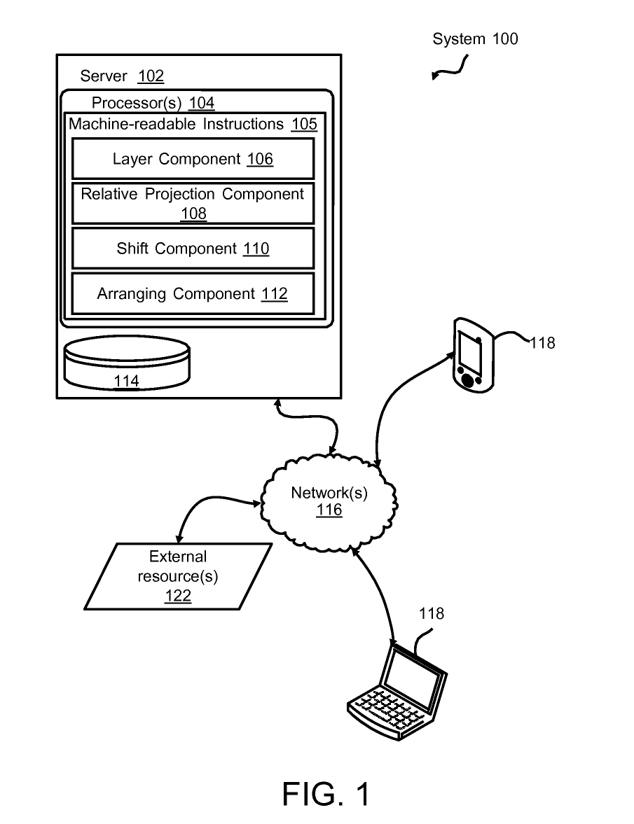

FIG. 1 illustrates a system 100 configured for arranging scenes of animated content to simulate three-dimensionality in the scenes, in accordance with one or more implementations. Animated content may include, for example, a cartoon animation, a computer animation, and/or other animated content. The animated content may be defined by one or more scenes. The scenes may be defined by a sequence of one or more frames. Individual frames may depict one or more objects of a scene. Objects may comprise entities that may be static within a scene (static over one or more frames of the scene), moving within a scene (e.g., convey motion over one or more frames of the scene), and/or some combination thereof. By way of non-limiting example, an object may comprise an animated character, a static character, a moving scenery element, a static scenery element, a foreground object, a background object, a middle ground object, objects positioned therebetween, and/or other objects.

In some implementations, three-dimensionality may be simulated by changing properties of objects within the scenes relative to each other. In some implementations, properties of an object may include one or more of a position within a layer of the scene, a simulated depth position, a size, an orientation, a simulated material property, and/or other properties of objects. In some implementations, the relative changes may be determined based on a position and/or orientation of a display of a computing platform presenting the scenes relative to a user's perspective of the display. User perspective may be associated with one or more of a distance of the user from the display, a viewing angle of the user relative the display, an orientation of the display, and/or other information.

By way of non-limiting example, by tilting a computing platform and/or otherwise changing an orientation of a display of the computing platform, the user's perspective of the display may change. These changes may result in property changes of one or more objects being effectuated throughout one or more frames of a scene. By way of non-limiting example, a change in the user's viewing perspective may cause one or more objects to positionally shift relative to other objects, and/or other changes. In some implementations, a positional shift may cause one or more surfaces of one or more objects that may have been occluded prior to the perspective change to subsequently be uncovered. In some implementations, a user may see partially around the sides of objects, observe parallax effects, observe dis-occlusions, and/or other three-dimensional effects. By way of non-limiting example, a positional shift may allow a user to “look around” objects presented in a scene.

In some implementations, individual ones of one or more objects depicted in one or more frames of a scene may be associated with a different depth layer of the scene. In some implementations, changing position, size, orientation, material properties, and/or other property of objects relative to each other may comprise changing properties of objects associated with a particular layer relative to objects associated with another layer. Depth layers may correspond to different depths in a simulated depth-of-field of the scenes. By way of non-limiting example, a foreground object presented in a scene may be associated with a layer having a closer simulated depth within a depth-of-field of a scene than a simulated depth of a layer associated with a background object. By way of non-limiting example, a middle ground object may be associated with a layer having a simulated depth within a depth-of-field of the scene that may be between simulated depths of a foreground object's layer and a background object's layer. In some implementations, objects in a scene may move between different simulated depth layers over the course of a scene (e.g., convey motion from a foreground position to a background position).

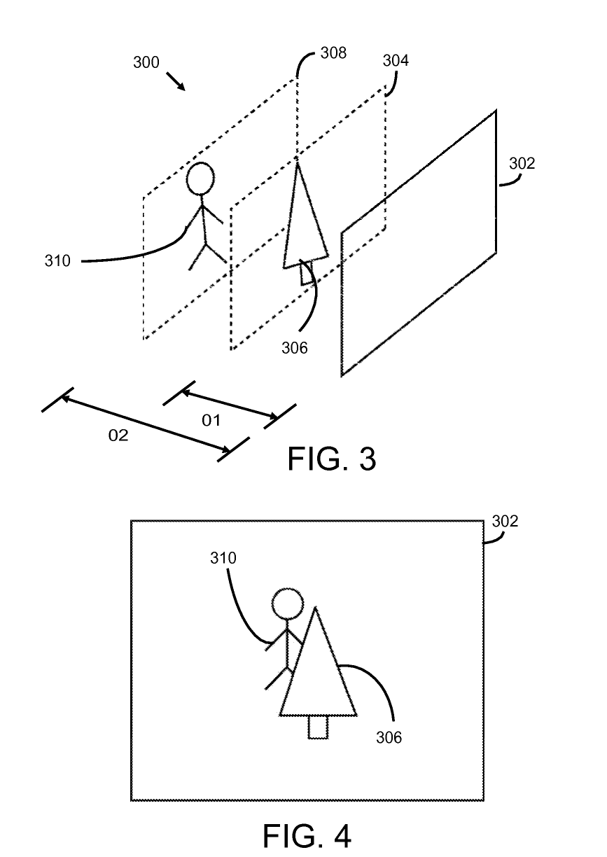

By way of non-limiting illustration, FIG. 3 shows a representation of an individual frame 300 of a scene of animated content illustrating simulated depth-of-field, in accordance with one or more implementations. The frame 300 and/or scene associated with the frame 300 may include a first object 306, a second object 310, and/or other objects. The first object 306 may be associated with a first layer 304. The second object 310 may be associated with a second layer 308. The first layer 304 may represent a first depth D1 within a simulated depth-of-field of the animated content relative to a viewing display 302 of a computing platform (not shown in its entirety in FIG. 3). The second layer 308 may be associated with a second depth D2 within the simulated depth-of-field of the animated content relative to the display 302. By way of non-limiting example, if the second object 310 were to be animated as being “behind” the first object 306, then D1 may be less than D2. Of course, in reality, the animated content is shown on a two-dimensional plane of the display 302, such that depths D1 and/or D2 are not actual depths within a computing platform but are representations of virtual depths within views of the presented animated content. By way of non-limiting example, a two-dimensional display 302 showing the first object 306 in front of the second object 310 as may be viewed by a user is shown in FIG. 4.

Returning to FIG. 1, in some implementations, animated content may be hosted for access by users over a network 116, such as the Internet. The system 100 may include a host server 102 configured to host animated content for access via computing platforms 118 associated with the users. The server 102 may obtain animated content locally from within electronic storage 114, from an external resource 122, and/or may from other sources. A computing platform 118 may include, for example, a cellular telephone, a smartphone, a laptop, a tablet computer, a desktop computer, a television set-top box, smart TV, a gaming console, a client device, and/or other device suitable for the intended purpose(s) presented herein. Users may access system 100 and/or animated content via computing platforms 118. In some implementations, a computing platform 118 may comprise and/or may communicate with one or more of an immersive virtual reality system (e.g., CAVEs), a head-mounted virtual reality display device, and/or other immersive display devices.

The server 102 may include one or more physical processors 104 and/or other physical components. The one or more physical processors 104 may be configured by machine-readable instructions 105. The machine-readable instructions 105 may comprise one or more of a layer component 106, a relative projection component 108, a shift component 110, an arranging component 112, and/or other components. Execution of the machine-readable instructions 105 may facilitate arranging scenes of animated content for presentation to users at computing platforms 118. In some implementations, information defining views and/or other information associated with the scenes of the animated content may be communicated (e.g., via streaming visual data, object/position data, and/or other state information) from server 102 to the computing platforms 118 for presentation on the computing platforms 118 via client/server architecture, and/or other communication scheme.

In some implementations, some or all of the functionality of server 102 may be attributed to computing platforms 118. By way of non-limiting example, in some implementations, the animated content may be hosted locally at the computing platforms 118 associated with the users. The computing platforms 118 may be configured by machine-readable instructions to arrange and/or present view of scenes of the animated content using information stored by and/or local to the computing platforms 118 (e.g., a cartridge, disk, a memory card/stick, flash memory, electronic storage, and/or other storage), and/or other information.

In some implementations, the layer component 106 may be configured to associate objects in the scenes of the animated content with discrete layers according to corresponding depth positions of the objects. Individual layers may correspond to different depths of simulated depth-of-field within the scenes (see, e.g., FIG. 3). In some implementations, the association of one or more objects with a layer may be based on information provided with the animated content, and/or other information. By way of non-limiting example, information that defines the animated content (e.g., source code) may include information that specifies different layers with which different objects of the animation may be associated. In some implementations, object/layer association information may be provided as metadata associated with the animated content, provided in the source code itself, and/or provided in other ways. By way of non-limiting example, the source code may include “tags,” “labels,” and/or other information that specifies the object and layer associations on a frame by frame and/or scene by scene basis.

In some implementations, association of one or more objects with a layer may be determined and/or derived from the animated content after it has been created. That is, the source code and/or metadata of the animated content may or may not indicate object/layer associations and/or object/layer association may be determined in other ways. By way of non-limiting example, the layer component 106 may be configured to determine and/or derive object/layer associations based on the source code, presented views of the scenes, and/or other information. In some implementations, the layer component 106 may be configured to determine which objects within a frame and/or scene may be represented at different depths of a simulated depth-of-field within the view of the frame and/or scene. In some implementations, a human user may carry out one or more association tasks. By way of non-limiting example, a human user may watch the animated content and manually determine associations between one or more objects and layers based on a frame by frame and/or scene by scene viewing of the content.

In some implementations, the layer component 106 may be configured to associate within a given frame one or more layers, wherein individual ones of the layers may contain a given number of partly transparent areas. In some implementations, to reduce bandwidth and/or storage costs, areas which may be transparent across one or more layers may be identified in order to determine a series of areas that may minimally contain non-transparent pixels and/or may contain only transparent pixels. A bin-packing algorithm and/or other technique may be used to calculate an efficient placement of these non-transparent pixels, creating a single “collage” sequence containing all non-transparent pixel sections for individual ones of the layers. Metadata (e.g., from an XML source) may encode the relative displacement of the layers along the depth-of-field axis, and/or the static placement of these areas. In some implementations, transparent area determinations may be adjusted in real-time according to a playback scenario.

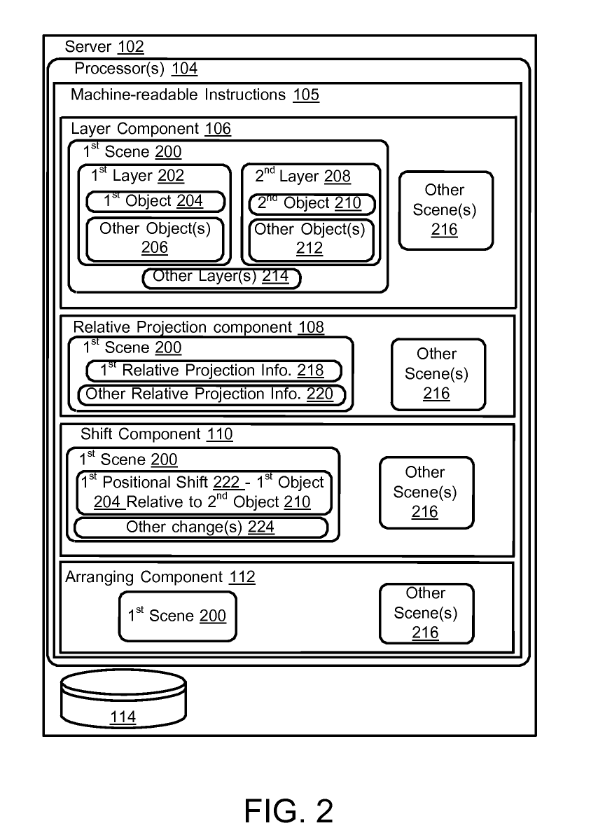

By way of illustration in FIG. 2, the layer component 106 may be configured to associate a first object 204 of a first scene 200 of animated content with a first layer 202. The layer component 106 may be configured to associate one or more other objects 206 with the first layer 202. The layer component 106 may be configured to associate a second object 210 of the first scene 200 with a second layer 208. The layer component 106 may be configured to associate other objects 212 with the second layer 208. The layer component 106 may be configured to associate other objects of the first scene 200 with other layers 214. The layer component 106 may be configured such that the first layer 202 may correspond to a first depth of a simulated depth-of-field of the first scene 200. The layer component 106 may be configured such that the second layer 208 may correspond to a second depth of the simulated depth-of-field of the first scene 200. The layer component 106 may be configured to associate objects of one or more other scenes 216 with other layers.

Returning to FIG. 1, the relative projection component 108 may be configured to determine relative projection information for individual ones of the scenes and/or frames. The relative projection information may convey one or both of a position and/or orientation of a display of a computing platform 118 presenting the scenes relative to a user's perspective of the display 118. In some implementations, relative projection information may convey one or more changes in the user's perspective of the display 118 over time.

User perspective may be determined in a variety of ways. In some implementations, user perspective relative a computing platform 118 may be accomplished by pose tracking, eye tracking, gaze tracking, face tracking, and/or other techniques. One or more techniques for determining user perspective may employ a camera and/or other imaging device included with or coupled to a computing platform 118. By way of non-limiting example, determining user perspective may be accomplished using a head-coupled perspective technique (HCP) such as the i3D application employed in iOS devices and/or other techniques.

In some implementations, user perspective may be determined based on sensor output from one or more orientation sensors, position sensors, accelerometers, and/or other sensors included in or coupled to the computing platform 118. By way of non-limiting example, assuming a “regular” and/or target viewing pose and/or orientation of a viewing user (e.g., a common viewing distances, viewing angle, and/or position of user viewing content on a display), by determining an orientation of a display of the computing platform 118 in three-dimensional space, a position and/or orientation of the display relative to the user may be determined.

By way of illustration in FIG. 2, the relative projection component 108 may be configured to determine first relative projection information 218 and/or other relative projection information 220 associated with the first scene 200. The first relative projection information 218 may correspond to a first user's perspective of the first scene 200 relative to a display of a first computing platform presenting the first scene 200. The first relative projection information 218 may correspond to one or more changes in the first user's perspective over time. By way of non-limiting example, the first relative projection information 218 may convey information indicative of the first user having a first perspective during a first period of time, a second perspective during a second period of time subsequent the first period of time, and/or other changes in perspective. By way of non-limiting example, the first period of time may encompass a first set of frames of the first scene 200. By way of non-limiting example, the second period of time may encompass a second set of frames of the first scene 200.

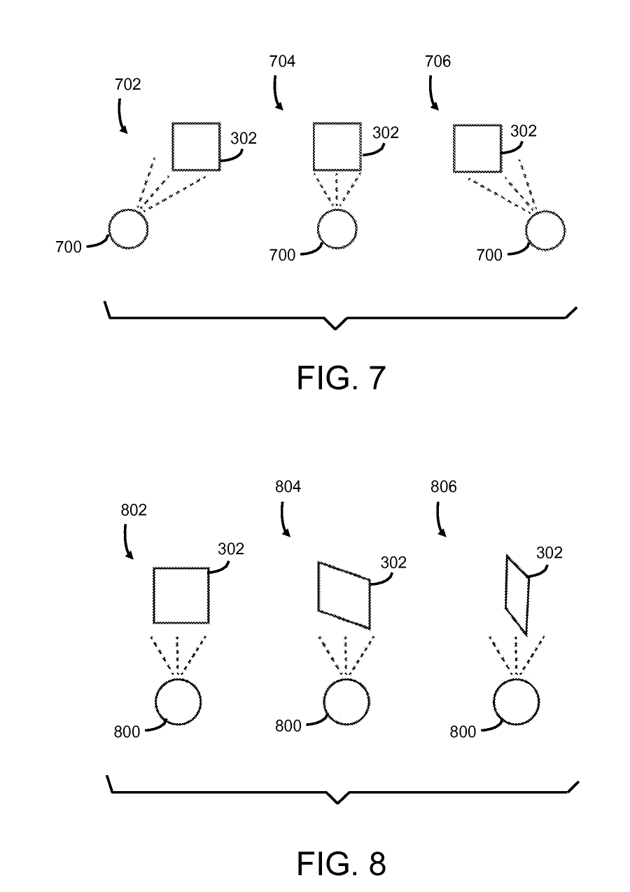

FIG. 7 and FIG. 8 illustrate different ways in which a user's perspective of presented animated content on a computing platform may change relative the computing platform presenting the content. It is noted that in FIG. 7 and FIG. 8 a computing platform is not shown in its entirety. Instead, for clarity only a display 302 is shown.

FIG. 7 illustrates different user perspectives 702, 704, and 706 relative a display 302 of a computing platform, in accordance with one or more implementations. The depictions of perspective 702, 704, and 706 may be based on different orientations of a user 700 relative the display 302 of the computing platform. By way of non-limiting example, the computing platform may be stationary and the user may be moving relative the display 302. This may include, for example, the user turning their head, moving past the display 302, and/or other user movement.

FIG. 8 illustrates different user perspectives 802, 804, and 806 relative the display 302 of a computing platform, in accordance with one or more implementations. The depiction of perspective 802, 804, and 806 may be based on different orientations of display 302 of the computing platform relative the user 800. By way of non-limiting example, the user 800 may be stationary and the display 302 may be moving, changing position, and/or changing orientation. This may include, for example, the user holding the display 302 and tilting and/or otherwise moving the display 302 within their field of view.

It is noted that the above descriptions of ways in which a user's perspective relative a display of a computing platform may change are not intended to be limiting. Instead, they are provided for illustration purposes and should not be considered limiting with request to how a user may view a display of a computing platform and/or how user perspective may be determined. By way of non-limiting example, in some implementations, a user perspective may change based on combinations of user-based and display-based changes as described above in connection with FIG. 7 and FIG. 8.

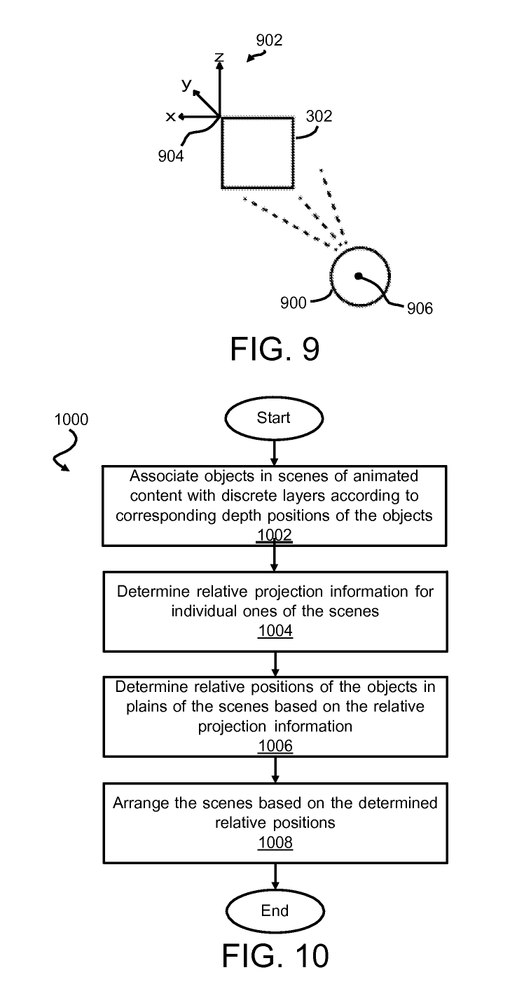

FIG. 9 illustrates an implementation of user 900 perspective being represented by point 906 within a coordinate system 902, and/or other information. In some implementations, using one or more techniques for determining user perspective relative a display of a computing platform, a representation of the user's perspective (e.g., position within three-dimensional space with respect to a display of a computing platform) may be represented by a point 906 within a coordinate system 902. By way of non-limiting example, the coordinate system 902 may comprise one or more of a Cartesian coordinate system, polar coordinate system, spherical coordinate system, and/or other type coordinate systems. The point 906 may be with reference to a coordinate origin 904 at the display 302, and/or other location. In some implementations, the roles of the display 302 and user 900 may be switched such that the user may be considered the origin of the coordinate system 902 while the position and/or orientation within three-dimensional space of the display 302 may be represented by a point. By way of non-limiting example, the point 902 may correspond to one or more of a distance from the display 302, a viewing angle of the user 900 in a vertical direction with respect to the display 302, a viewing angle of the user 900 in a horizontal direction with respect to the display 302, and/or other information.

Returning to FIG. 1, the shift component 110 may be configured to determine relative property changes of objects in layers of the scenes based on the relative projection information. In some implementations, the shift component 110 may be configured such that changes to one or more objects may be carried out on layer-wide basis. By way of non-limiting example, one or more changes may be determined for one or more layers such that changes may be determined for one or more of the objects associated with individual ones of the layers. In some implementations, properties of an object may include one or more of a position within a layer of a scene, a layer association of the object (e.g., a depth position with a simulated depth-of-field), a size, an orientation, a simulated material property, and/or other properties of the object depicted in the scenes.

By way of non-limiting example, a change in the user's viewing perspective may cause one or more objects to positionally shift relative other depicted objects and/or other property changes may occur. By way of non-limiting example, a positionally shift may result in one or more surfaces that may have been occluded prior to the perspective change to then be “uncovered.” By way of non-limiting example, a user may tilt a computing platform 118 in a first direction. One or more objects in a scene being presented may positionally shift in relation to the first direction. By way of non-limiting example, a user may turn their head in a second direction. One or more objects in a scene being presented may positionally shift in relation to the second direction.

In some implementations, a positional shift may allow a user to “look around” objects presented in a scene. By way of non-limiting example, in addition and/or alternatively to a positional shift, objects may change orientation (e.g., rotate), change simulated material properties, and/or may change in other ways in relation to the user's perspective.

By way of non-limiting example, changing properties of one or more objects in a scene based on user perspective may facilitate simulating a parallax effect within the presented scenes. Parallax may correspond to a displacement and/or difference in the apparent position of one or more objects viewed along different lines of sight (e.g., different user perspectives of a display). By way of non-limiting example, as a user's perspective moves from side to side relative a computing platform, the objects positioned deeper within a depth-of-field may appear to positionally shift slower relative to objects that may be shallower within the simulated depth-of-field.

By way of illustration in FIG. 2, the shift component 110 may be configured to determine a first positional shift 222 and/or other property changes 224 of the first object 204 relative the second object 210 based on the first relative projection information 218. By way of non-limiting example, the first object 204 may be determined to positionally shift in relation to the second object 210 in responsive to a change in a user's perspective of the display of the first computing platform while viewing the first scene 200. The positional shift may facilitate a simulation of three-dimensionality of the first scene 200. By way of non-limiting example, based on a change in user perspective conveyed by the first relative projection information 218, at a first point in time the first object 204 may be determined to be at a first position relative a position of the second object 210 within the first scene 200. At a subsequent point in time, the first object 204 may then be determined to change to a second position relative a position of the second object 210 within the first scene 200.

In some implementations, a speed at which the first object 204 changes from a first position to a second position may be determined based on the determined change in user perspective. By way of non-limiting example, a speed at which objects may positionally shift based on user perspective may be based on one or more of a speed at which the users changes their perspective, the corresponding layer associated with the objects, and/or other information. By way of non-limiting example, to simulate a parallax effect, objects associated with layers that may be deeper within a simulated depth-of-field may positionally shift slower than objects associated with layers that may be shallower within the simulated depth-of-field. Other property changes may be determined.

By way of non-limiting example, the shift component 110 may be configured to determine relative orientation changes of the objects based on the relative projection information. By way of non-limiting example, based on change in user perspective conveyed by the first relative projection information 218, over the first period of time the first object 204 may have a first orientation within the first scene 200. During the second period of time, the first object 204 may then be determined to change to a second orientation within the first scene 200. By way of non-limiting example, the first object 204 may rotate in relation to the second object 210 responsive to the change in the user's perspective of the display while viewing the first scene 200.

By way of non-limiting example, the shift component 110 may be configured to determine relative size changes of the objects based on the relative projection information. By way of non-limiting example, the shift component 110 may be configured to determine, responsive to the change in the user's perspective of the display while viewing the first scene 200, that the first object 204 may increase in size relative the second object 210.

By way of non-limiting example, the shift component 110 may be configured to deterring surface property changes of the objects in the scenes based on the relative projection information. By way of non-limiting example, the shift component may be configured to determine that a first surface of the first object 204 may change from having a first surface property to having a second surface property responsive to the change in the user's perspective of the display while viewing the first scene 200.

Returning to FIG. 1, the arranging component 112 may be configured to arrange scenes based on the determined property changes. By way of non-limiting example, the arranging component 112 may be configured to arrange objects in the scenes based on one or more of determined positional shifts, size changes, depth change, material property changes, and/or other changes. By way of non-limiting example, scenes may be arranged based on relative positions of objects.

As an illustrative example in FIG. 2, the arranging component 112 may be configured such that the first scene 200 may be arranged based on the determined first positional shift 222 and/or other determined changes associated with the first object 204 and/or the second object 210.

FIGS. 4-6 illustrate exemplary implementations scene arrangements. The scene arrangements may be based on one or more property changes of objects between frames of a scene. The property changes may be based on one or more changes in user perspective over time. In some implementations, the sequence of frames from FIG. 4 to FIG. 6 may correspond to positional shifts of a first object 306 relative a second object 310 to simulate a parallax effect based on changes of user perspective while viewing a scene. By way of non-limiting example, the change in user perspective over the frames may simulate three-dimensionality by allowing the user to look behind the first object 306 to view the second object 310.

FIG. 4 illustrates a first arrangement of the first object 306 and second object 310 within a frame of a scene. By way of non-limiting example, the first arrangement may correspond to a first user perspective. By way of non-limiting example, the first arrangement shown in FIG. 4 may correspond to a first user perspective the same or similar to perspective 706 shown in FIG. 7 and/or perspective 806 shown in FIG. 8.

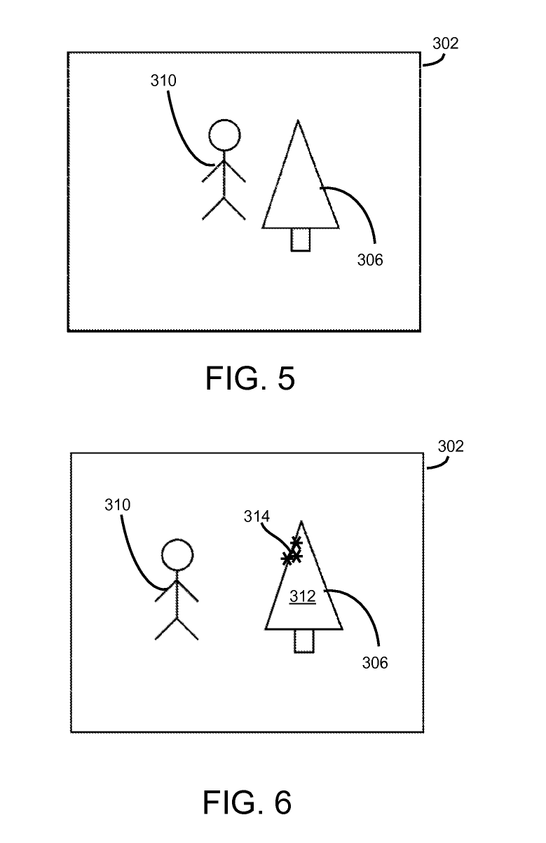

FIG. 5 illustrates a second arrangement of the first object 306 and second object 310 within a frame of a scene. By way of non-limiting example, the second arrangement may correspond to a second user perspective. In some implementations, the second arrangement may correspond to a positional shift of the first object 306 relative the second object 310 (e.g., shifted relative the positions shown in the first arrangement of FIG. 4). By way of non-limiting example, the second arrangement may correspond to a second user perspective the same or similar to perspective 704 shown in FIG. 7 and/or perspective 804 shown in FIG. 8.

FIG. 6 illustrates a third arrangement of the first object 306 and second object 310 within a frame of a scene. By way of non-limiting example, the third arrangement may correspond to a third user perspective. In some implementations, the third arrangement may correspond to a positional shift of the first object 306 relative the second object 310 (e.g., shifted relative the positions shown in the first arrangement of FIG. 4 and/or the second arrangement of FIG. 5). By way of non-limiting example, the second arrangement may correspond to a third user perspective the same or similar to perspective 702 shown in FIG. 7 and/or perspective 802 shown in FIG. 8. In some implementations, the third arrangement may correspond to a change in simulated material property of a first surface 312 of the first object 306. By way of non-limiting example, the first surface 310 may reflect an amount of simulated light 314 based on the users viewing perspective of the scene and the corresponding new positions of the first object 312 and/or section object 310 (relative the arrangements in FIG. 4 and FIG. 5). By way of non-limiting example, based on the positional shift, the first object 306 may be determined to have moved to a position within the frame where simulated light within the scene hits the first surface 312 to simulate glare. In some implementations, other surface property changes may include revealing specular highlight reflections according to the materials represented in the scene, and/or other changes.

The above descriptions of scene arrangements in FIGS. 4-6 are provided for illustrative purposes only. For example, the arrangements of the scenes and corresponding user perspectives are not to be considered limiting with respect to how properties of objects may change with respect to user perspective relative a computing platform.

Returning to FIG. 1, server 102, computing platforms 118, and/or external resources 122 may be operatively linked via one or more electronic communication links. For example, such electronic communication links may be established, at least in part, via a network (e.g., network(s) 116) such as the Internet and/or other networks. It will be appreciated that this is not intended to be limiting and that the scope of this disclosure includes implementations in which server 102, computing platforms 118, and/or external resources 122 may be operatively linked via some other communication media.

The external resources 122 may include sources of information that are outside of system 100, external entities participating with system 100, and/or other resources. In some implementations, some or all of the functionality attributed herein to external resources 122 may be provided by resources included in system 100.

Server 102 may include electronic storage 114, one or more processors 104, and/or other components. Server 102 may include communication lines or ports to enable the exchange of information with a network and/or other computing platforms. Illustration of server 102 in FIG. 1 is not intended to be limiting. The server 102 may include a plurality of hardware, software, and/or firmware components operating together to provide the functionality attributed herein to server 102. For example, server 102 may be implemented by a cloud of computing platforms operating together as server 102.

Electronic storage 114 may comprise electronic storage media that electronically stores information. The electronic storage media of the electronic storage may include one or both of storage that is provided integrally (i.e., substantially non-removable) with the respective device and/or removable storage that is removably connectable to the respective device. Removable storage may include, for example, a port or a drive. A port may include a USB port, a firewire port, and/or other port. A drive may include a disk drive and/or other drive. Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 114 may include one or more virtual storage resources (e.g., cloud storage, a virtual private network, and/or other virtual storage resources). Electronic storage 114 may store files, software algorithms, information determined by processor(s), and/or other information that enables the respective devices to function as described herein.

Processor(s) 104 is configured to provide information-processing capabilities in the server 102. As such, processor(s) 104 may include one or more of a digital processor, an analog processor, a digital circuit designed to process information, an analog circuit designed to process information, a state machine, and/or other mechanisms for electronically processing information. Although the processor(s) 104 are shown in FIG. 1 as single entity within the server 102, this is for illustrative purposes only. In some implementations, the processor(s) 104 may include one or more processing units. These processing units may be physically located within the same device or may represent processing functionality of a plurality of devices operating in coordination.

For example, processor 104 may be configured to execute machine-readable instructions 105 including components 106, 108, 110, and/or 112. Processor 104 may be configured to execute components 106, 108, 110, and/or 112 by software; hardware; firmware; some combination of software, hardware, and/or firmware; and/or other mechanisms for configuring processing capabilities on processor 104. It should be appreciated that, although components 106, 108, 110, and/or 112 are illustrated in FIG. 1 as being co-located within a single processing unit, in implementations in which processor 104 includes multiple processing units, one or more of components 106, 108, 110, and/or 112 may be located remotely from the other components. The description of the functionality provided by the different components 106, 108, 110, and/or 112 described above is for illustrative purposes and is not intended to be limiting, as any of components 106, 108, 110, and/or 112 may provide more or less functionality than is described. For example, one or more of components 106, 108, 110, and/or 112 may be eliminated, and some or all of its functionality may be provided by other ones of components 106, 108, 110, 112 and/or other components.

FIG. 10 illustrates an implementation of a method 1000 of arranging scenes of animated content to simulate three-dimensionality by shifting objects corresponding to different depth layers of the scenes relative to each other based on a position and/or orientation of a display of a computing platform presenting the scenes relative to a user's perspective of the display. The operations of method 1000 presented below are intended to be illustrative. In some implementations, method 1000 may be accomplished with one or more additional operations not described and/or without one or more of the operations discussed. Additionally, the order in which the operations of method 1000 are illustrated in FIG. 10 and described below is not intended to be limiting.

In some implementations, method 1000 may be implemented in one or more processing devices (e.g., a computing platform, a digital processor, an analog processor, a digital circuit designed to process information, an analog circuit designed to process information, a state machine, and/or other mechanisms for electronically processing information) and/or one or more other components. The one or more processing devices may include one or more devices executing some or all of the operations of method 1000 in response to instructions stored electronically on an electronic storage medium. The one or more processing devices may include one or more devices configured through hardware, firmware, and/or software to be specifically designed for execution of one or more of the operations of method 1000.

Referring now to method 1000 in FIG. 10, at an operation 1002, objects in the scenes of the animated content may be associated with discrete layers according to corresponding depth positions of the objects. In some implementations, operation 1002 may be performed by a layer component the same as or similar to layer component 106 (shown in FIG. 1 and described herein).

At an operation 1004, relative projection information for individual ones of the scenes may be determined. In some implementations, operation 1004 may be performed by a relative projection component the same as or similar to relative projection component 108 (shown in FIG. 1 and described herein).

At an operation 1006, relative positions of the objects in two-dimensional layers of the scenes based on the relative projection information may be determined. Other property changes to the object in layers of the scenes may be determined. In some implementations, operation 1006 may be performed by a shift component the same as or similar to shift component 110 (shown in FIG. 1 and described herein).

At an operation 1008, scenes may be arranged based on the determined relative positions and/or other determined changes. In some implementations, operation 1008 may be performed by an arranging component the same as or similar to arranging component 112 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for arranging scenes of animated content to simulate three-dimensionality by shifting objects corresponding to different depth layers of the scenes relative to each other based on a position and/or orientation of a display of a computing platform presenting the scenes relative to a user's perspective of the display, the system comprising:
one or more physical processors configured by computer-readable instructions to:
associate objects in the scenes of the animated content with discrete layers according to corresponding depth positions of the objects, individual layers corresponding to different depths of simulated depth-of-field within the scenes, a first object of a first scene being associated with a first layer and a second object of the first scene being associated with a second layer, wherein the first layer corresponds to a first depth of a simulated depth-of-field of the first scene and the second layer corresponds to a second depth of the simulated depth-of-field of the first scene;
determine relative projection information for individual ones of the scenes, the relative projection information conveying one or both of the position or the orientation of the display presenting the scenes relative to the user's perspective of the display, the relative projection information including first relative projection information associated with the first scene;
determine relative positions of the objects in the layers of the scenes based on the relative projection information, such that the first object is determined to positionally shift in relation to the second object responsive to a change in the user's perspective of the display while viewing the first scene, the positional shift facilitating a simulation of three-dimensionality of the first scene; and
arrange the scenes based on the determined relative positions, the first scene being arranged based on the determined positional shift of the first object relative the second object.

2. The system of claim 1, wherein the one or more physical processors are further configured by computer-readable instructions such that the determined relative projection information conveys changes in the user's perspective of the display over time.

3. The system of claim 1, wherein the one or more physical processors are further configured by computer-readable instructions to determine relative size changes of the objects based on the relative projection information, such that the first object is determined to increase in size relative the second object responsive to the change in the user's perspective of the display while viewing the first scene.

4. The system of claim 1, wherein the one or more physical processors are further configured by computer-readable instructions to determine relative orientation changes of the objects based on the relative projection information, such that the first object is determined to rotate in relation to the second object responsive to the change in the user's perspective of the display while viewing the first scene

5. The system of claim 1, wherein the one or more physical processors are further configured by computer-readable instructions to determine surface property changes of the objects in the scenes based on the relative projection information, such that a first surface of the first object having a first surface property is determined to change to a second surface property responsive to the change in the user's perspective of the display while viewing the first scene.

6. The system of claim 1, wherein the one or more physical processors are further configured by computer-readable instructions such that relative projection information is determined based on sensor output from one or more position and/or orientation sensors of the computing platform.

7. The system of claim 1, wherein the one or more physical processors are further configured by computer-readable instructions such that relative projection information is determined based on tracking the user's pose while viewing the first scene.

8. The system of claim 1, wherein the one or more physical processors are further configured by computer-readable instructions such that the positional shift of the first object relative the second object responsive to changes in the user's perspective simulates a parallax effect in the first scene such that one or more occluded surfaces of one or both of the first object or second object are uncovered based on the changes.

9. The system of claim 1, wherein the display is an immersive display device.

10. The system of claim 1, wherein the one or more physical processors are further configured by computer-readable instructions such that the user's perspective is based on one or more of a distance of the user from the display, a viewing angle of the user relative the display, or an orientation of the display in three-dimensional space.

11. A computer-implemented method of arranging scenes of animated content to simulate three-dimensionality by shifting objects corresponding to different depth layers of the scenes relative to each other based on a position and/or orientation of a display of a computing platform presenting the scenes relative to a user's perspective of the display, the method being implemented in a computer system including one or more physical processors and storage media storing computer-readable instructions, the method comprising:
associating objects in the scenes of the animated content with discrete layers according to corresponding depth positions of the objects, individual layers corresponding to different depths of simulated depth-of-field within the scenes, wherein associating objects includes associating a first object of a first scene with a first layer and a second object of the first scene with a second layer, wherein the first layer corresponds to a first depth of a simulated depth-of-field of the first scene and the second layer corresponds to a second depth of the simulated depth-of-field of the first scene;
determining relative projection information for individual ones of the scenes, the relative projection information conveying one or both of the position or the orientation of the display presenting the scenes relative to the user's perspective of the display, including determining first relative projection information associated with the first scene;
determining relative positions of the objects in the layers of the scenes based on the relative projection information, including determining that the first object positionally shifts in relation to the second object responsive to a change in the user's perspective of the display while viewing the first scene, the positional shift facilitating a simulation of three-dimensionality of the first scene; and
arranging the scenes based on the determined relative positions, including arranging the first scene based on the determined positional shift of the first object relative the second object.

12. The method of claim 11, wherein relative projection information conveys changes in the user's perspective of the display over time.

13. The method of claim 11, additionally comprising:
determining relative size changes of the objects based on the relative projection information, including determining that the first object increases in size relative the second object responsive to the change in the user's perspective of the display while viewing the first scene.

14. The method of claim 11, additionally comprising:
determining relative orientation changes of the objects based on the relative projection information, including determining that the first object rotates in relation to the second object responsive to the change in the user's perspective of the display while viewing the first scene.

15. The method of claim 11, additionally comprising:
determining surface property changes of the objects in the scenes based on the relative projection information, including determining that a first surface of the first object changes from having a first surface property to having a second surface property responsive to the change in the user's perspective of the display while viewing the first scene.

16. The method of claim 11, wherein relative projection information is determined based on sensor output from one or more position and/or orientation sensors of the computing platform.

17. The method of claim 11, wherein relative projection information is determined based on tracking the user's pose while viewing the first scene.

18. The method of claim 11, wherein the positional shift of the first object relative the second object responsive to changes in the user's perspective simulates a parallax effect in the first scene such that one or more occluded surfaces of one or both of the first object or second object are uncovered based on the changes.

19. The method of claim 11, wherein the display is an immersive display device.

20. The method of claim 11, wherein the user's perspective is based on one or more of a distance of the user from the display, a viewing angle of the user relative the display, or an orientation of the display in three-dimensional space.
